(19) United States
(12) Patent Application Publication
(10) Pub. No.: US 2004/0075995 A1
(43) Pub. Date: Apr. 22, 2004

(54) Illuminated workrooms substantially devoid of blue and UV light, and light sources, including fluorescent lamps, adapted to block blue and UV light emission

(76) Inventor: William Raggio, Del Mar, CA (US)

Correspondence Address: FUESS & DAVIDENAS, Suite II-G, 10951 Sorrento Valley Road, San Diego, CA, 92121-1613, US

(21) Appl. No.: 10/274,186

(22) Filed: Oct. 17, 2002

(51) Int. Cl. F21V 13/00

(52) U.S. Cl. 362/33; 362/293

(57) ABSTRACT

An electric light emitting ultraviolet and/or blue light is covered with material substantially opaque to light emitted in the blue and/or ultraviolet spectral regions and substantially transparent in other visible spectral regions. A standard tubular fluorescent light can be wrapped with polyimide film, or a standard incandescent light bulb can be coated with polyimide resin, so as to emit light that is UV- and/or blue-free. The intensity of light emitted in remaining, un-blocked, wavelengths is sufficient to illuminate, by way of example, a workroom where industrial processes best shielded from UV and/or blue light can transpire.

### BACKGROUND OF THE INVENTION

1. Field of the Invention

The present invention generally concerns light sources free of ultraviolet and/or blue wavelength (frequency) light emission: i.e., UV-free and or blue-free light sources.

The present invention particularly concerns conventional fluorescent and incandescent light sources, emitting light in a broad spectrum including UV and blue wavelengths (frequencies), that are covered so as to shield against any emission of UV and/or blue light.

2. Description of the Prior Art

2.1 The Requirement for UV-Free and/or Blue-Free Lighting

In many plastic, chemical and resin technologies any exposure to UV and/or blue wavelengths can be harmful to the desired product and can compromise the integrity of the production process. Even though all production processes sensitive to these radiation wavelengths could be performed in shielded, light-tight, containers, it is often more economical and more feasible, not to mention safer, to permit workers to work with these sensitive products in open areas in the presence of relatively normal ambient light. Good lighting is critical in the process of making these sensitive products for both safety and practical reasons.

Products that should not be exposed to UV light, at least prematurely, include those incorporating UV curable resins. The advantages of UV curable resins over traditional resins are many. Non-UV curable resins produce hazardous and environmentally unsound gases and vapors when cured. These gases are not only unhealthy, but are increasingly forbidden by new Government regulations. Conversely, UV curable resins have little or no by-products from curing.

UV-curable resins also cure considerably faster than other resins; typically taking seconds to cure as opposed to hours and even days for other resins.

Some common products incorporating UV-curable resins in their manufacture include the following:

Most soft contact lenses circa 2002 are fabricated using a UV curable monomer. The monomer is shaped, normally by molding, as desired, and then cured with blue/ultraviolet light radiation. Manufacturers of soft contact lenses using this process include Ciba Vision, Johnson & Johnson, and Baush & Lomb. Factories producing these products are extensive, and have a large demand for light sources in which blue and ultraviolet light radiation is either absent or blocked.

Fabricators of plywood and other composite wood products have adapted UV-curable fillers and coatings as being far more economical and environmentally friendly than traditional resins. Additionally, U.S. Government regulation of traditional resins in increasing. Factories producing UC-curable composite wood products are likewise very extensive, and with a requirement for light sources in which blue and ultraviolet light radiation is either absent or blocked.

Many products such as automobiles and furniture are now coated with UV-curable “top coats” to protect their underlying finishes at a materials, application labor, and environmental cost that is generally much less than traditional varnishes, lacquers and paints. The graphics industry is one of the largest users of UV curable products, using both UV-curable printing ink and overprint UV-curable varnish.

Finally, in the chemical industry in general many chemicals, inks, plastics and adhesives are ultraviolet- and/or blue-light sensitive, and can be compromised by unintended exposure to UV and/or blue light. It is generally preferred, if not also demanded, to guarantee the quality of these products by completely avoiding exposure to UV and/or blue light during manufacture, and until the finished products can be placed in light proof containers.

As a specific example of a UV-sensitive chemical process, U.S. Pat. No. 5,350,663 to Blum, et al. for PRODUCTION OF STRUCTURED LAYERS OF HEAT-RESISTANT POLYCONDENSATES teaches that structured layers of heat-resistant polycondensates can be prepared by a process wherein ethylenically unsaturated tetracarboxylates or adducts or salts of tetracarboxylates, which still contain at least one unesterified carboxylic acid group, with ethylenically unsaturated amines, amides or onium compounds mixed with compounds which contain amino, isocyanide or blocked isocyanide groups and can be subjected to polycondensation with the tetracarboxylates are applied as a layer to a substrate, this layer is exposed through a negative, the unexposed, soluble parts are then removed and the insoluble parts are converted into the final polycondensate form at elevated temperatures. In particular, during preparation of mixtures of ethylenically unsaturated tetracarboxylates and a diamino compound all work should be carried out in a laboratory or other facility with UV-free light.

2.2 Previous Sources of UV-Free Light

Previous sources of light that is reduced in ultraviolet (UV) and/or blue light components, whether for broad areas or not, and/or workroom-level intensity (or higher) illumination levels or not, include the following.

2.2.1 Gold-Coated Light Sources

Encapuslite International, Inc., of Rosenberg, Tex., USA, sells circa 2002 “Encapsulite™ PC Gold Safety Coated Fluorescent Lamps” and also ““Encapsulite™ PC Gold Safety Tubeguards”. Designed for the semiconductor industry, standard fluorescent lamps are fitted with a sleeve made of PET (polyethylene terephthalate) to which a thin film of gold has been applied, the gold being unsuitable for direct application to the glass tube of the fluorescent lamp. The applied gold film is claimed to block all light emissions below 500 nanometers, meaning blue and ultraviolet light.

Alas, the gold film also blocks a significant portion of light emission in other visual frequency (wavelength) ranges, and the lights are quite dim, producing only about half of the normal light output to be expected from standard T8 and T12 diameter fluorescent lamps in these ranges, and thus only about half of what will be seen to be the substantially 100% light output of the lamps of the present invention in these ranges.

2.2.2 Light-Emitting Diode UV-Free Light Sources

Light emitting diodes (LED) are electronic elements which produce light in different colors. Generally, those elements are used in applications for LED displays. Their physical characteristics of pure color, low temperature, and small size have promoted widespread use. LEDs can be made with limited spectral range. For example, the maxks™ LEDs of esw GmbH & Co. KG, Breinig, Germany, are claimed to be pure and constant in color, producing an IR/UV free light. See <http://www.esw-stolberg.com/eng/eng.html> on the World Wide Web circa 2002.

In another use of LEDs, the Heine Alpha otoscopic diagnostic set is stated to use Heine's specially engineered 2.5V XHL (Xenon-Halogen) illumination in order to provide the brightest and whitest UV-free light for accurate otoscopic examinations.

Finally, the Satellite Desk Lamp of Bio-Brite Bright Light Products is believed to use like space age LED (light-emitting diodes as does the SolarMax “Virtual Sunlight Visor” product of the same company. The Satellite Desk Lamp reportedly delivers 10,000 lux of UV free light up to 20”. See <http://www.biobriteinc.com> on the World Wide Web circa 2002.

2.2.3 Other UV-Free Light Sources

The Fibre Optic Light Source product of Preservation Equipment Ltd. [“PEL”], England, is claimed to provide a safe heat free and UV free bright light used for back illumination in bound books for research of water marks, repairs and photography. Since no electricity is connected to the actual light sheet or lead, the sheet is safe to work in damp situations. The very thin (1.8 mm) light sheet is water resistant, but not waterproof and should not be immersed in water. Three settings for high and low light intensity with an off position are provided. The size of the sheet is 280×210×1.8 mm. The technology behind this particular light source of the “panelescent” type which types been in existence for some years is not completely divulged, but this sheet light source is not a fluorescent tube. See <http://www.preservationequipment.co.uk/428.html” on the World Wide Web circa 2002.

The Scandles product is a multi-tasking portable fluorescent light source for digital, video and film imaging. It is also used for conservation task lighting of art and artifacts. The source is a constant, easily transported, full-spectrum, UV and heat free, daylight or tungsten-balanced source of illumination. The source reported produces no HEAT and no UV, and exhibits at least 4 times the electrical efficiency per lumen for the green output. Daylight fluorescent is reportedly 8 times the blue output. Scandles is self ballasted and flicker free (39 kHz), drawing only 1.6 Amp (200 watt model) which, with reflector, produces a light of quantity and quality similar to a 575 W HMI with a CHIMERA softbox (420 Fc/M). Its 10,000 hr. 5500° K lamps can be switched on or off 2 lamps at a time and exchanged with 3000° K or other color balanced lamps. See <http://www.plumeltd.com/scandle.htm> on the World Wide Web circa2002.

2.3 Polyimide Film

A most preferred embodiment of a light source in accordance with the present invention will be seen to employ polyimide film. Polyimide is a widely used organic polymer that exhibits exceptional chemical, thermal, electrical and mechanical performance. It is in particular very tolerant of high temperatures.

Polyimide was originally developed and patented by Dupont Corp. In it's raw form it is presently manufactured by relatively few companies world wide. Among these companies the Kapton@ product is made by Dupont Corp, the Upilex product by Ube Ind., the Apical product by Kaneka Corp, the Ultem produce by General Electric and the Aurum product by Mitsui.

Polyimide is particularly formed as films by a number of companies including by DuPont under its Kapton™ brand, and by Westlake Plastics Corporation under its Imidex™ brand.

A unique characteristic of polyimide it that it is well known to be a very good absorber of both UV and if desired, blue wavelength (frequency) light. The exact wavelengths filtered can be determined by both (i) the thickness of the polyimide chosen and (ii) the formulation of polyimide. Data on the light transmittance of polyamide at many, different thicknesses and formulations is available from the manufacturers.

### SUMMARY OF THE INVENTION

The present invention contemplates wrapping or coating polyimide films on lamps as a block to UV and/or blue radiation otherwise emitted by these lamps. The present invention also contemplates workrooms adequately lighted entirely by broad-spectrum electric lamps from which UV and/or blue radiation otherwise emitted is blocked by a polyimide film or coating upon the electric lamp while other visible light emitted by the electric lamp is substantially totally transmitted by the coating, and serves to illuminate the workroom.

In a most preferred, exemplary, embodiment, a transparent thin layer of polyimide film is adhered or applied to a standard lamp, normally of a glass envelope fluorescent or incandescent type. The polyimide may also be applied as a coating to a standard lamp. Still further, the polyimide may be applied as a film (to a flat surface) or as a coating to an otherwise transparent or translucent surface of a fixture holding the standard lamps.

The decision as to whether to block the emission of UV and/or blue light radiation by applying polyimide directly to an electric lamp, or instead to a fixture holding one or more electric lamps, is a function of, among other things, (i) the premium in cost of a electric lamp with applied polyimide versus the generally much larger area of a fixture with applied polyimide, (ii) the propensity of the fixture versus the electric lamp to “leak” ultraviolet or blue light, including through areas where the polyimide covering may become physically damaged, (iii) the ability of the fixture to reliably close “light tight” save where light is emitted through the applied polyimide, (iv) the longevity of the electric lamps versus the fixture, and (v) the ease and cost of replacement and repair (if possible) of each of the electric lamps and the fixture. The polyimide covering can sustain physical damage. Normally it is not desirable to throw away, most typically, an entire ceiling lighting fixture, or at least its diffusion surface, simply because the polyimide applied to this diffusion surface has become scratched. Thus, forbearing any proven workability of a “fixture light-tight save through polyimide-filtered emission areas” and “polyimide damage touch-up kit”, it is presently, circa 2002, deemed safer and better to apply polyimide directly to the electric lamps.

The preferred electric lamps to which polyimide is applied may in particular be either (i) a standard fluorescent lamps, 48″ or longer in length, or (ii) a standard incandescent light bulb.

The most preferred polyimide film is in thicknesses less than 0.0005″, at which thickness the film is still is a very effective blocker of UV radiation while transmitting essentially 100% of visible light outside these spectral regions. Polyimide film of this thickness is commercially available.

The method of applying the polyimide film is preferably one of the following:

First, polyimide film may be (i) procured in self-adhesive, roll, form, and (ii) stuck onto the surface of fluorescent lamp by wrapping it completely around the tube.

Second, a polyimide film—which is not normally of a self-adhesive type, but which can be of this type—is applied to the tube of a fluorescent lamp by use of a separate adhesive. This adhesive may be applied to the polyimide film, and/or directly onto the surface of the lamp.

Third, polyimide film can be procured as heat-shrink tubing. A tube of appropriate diameter is simply slid over the tube of a fluorescent lamp, and shrunk to a tight fit by application of heat normally in the form of hot air. The shrunken polyimide tube can be carefully trimmed so that no light escapes at the end regions of the fluorescent lamp.

Fourth, polyimide film (which may, or may not, be itself adhesive) by use of a double-sided-sticky tape.

Fifth, polyimide can be applied to the surfaces of both fluorescent and incandescent lamps (and others) by coating the lamp with polyimide resin, and then curing the resin in situ upon the lamp. Clearly this is alternative to making a film from the resin and then placing the film around the lamp as in methods 10-4). This fifth method is superior for standard incandescent lamp bulbs and other light emitters of complex contour that do not wrap well nor easily with film.

It is also theoretically possible, as a sixth method, to position polyimide in either film or resin form at, and on, the interior of the glass envelope of a lamp—although this requires special construction of the lamp, and can be deleterious to the performance of some lamps such as common tungsten filament incandescent lamps.

The most preferred method is a combination of methods 1) and 3) where a self-adhesive polyimide film is first wrapped around the preferred fluorescent tube while double-sided-sticky tape is used only at the beginning and the end of a wrap. Double-sided-sticky tape is also used as necessary to preclude any light leakage at the ends of the fluorescent light tube. This construction seems to give the best transmission of visible light while simultaneously realizing optimal blocking of UV and/or blue radiation.

It should be noted for all methods that, because many lamps may have a reduction in diameter at the electrodes, an opaque or polyimide resin filler may be needed in order to block light from leaking out of the ends of the lamp.

Standard light bulbs wrapped with polyimide film, or coated with polyimide resin, can be packed, shipped, placed and installed exactly like standard off-the-shelf light bulbs.

1. An Illuminated Workroom

Accordingly in one of its aspects the present invention is embodied in a workroom entirely adequately illuminated only by light sources that, in serving to illuminate the workroom, are substantially devoid of blue and ultraviolet wavelengths.

The workroom so illuminated includes (1) a room enclosing a volume; and (2) a broad spectrum light source illuminating the workroom with light including light in blue and ultraviolet spectral regions and also visible light outside these spectral regions, which light source is covered with (3) material substantially opaque to light emitted by the light source in the blue and ultraviolet spectral regions but substantially totally transmissive to visible light emitted by the light source outside these spectral regions.

The source of light is preferably a wavelength-filtered fluorescent light.

The source of light is more preferably a fluorescent light tube emitting light including in blue and ultraviolet spectral regions, but covered with a polyimide material substantially opaque to light emitted in the blue and ultraviolet spectral regions but substantially totally transmissive to visible light emitted by the fluorescent light outside these spectral regions.

The material is preferably either (i) polyimide film or (ii) polyimide resin. If (i) polyimide film, then the material is still more preferably self-adhesive polyimide film.

2. A Wavelength-Filtered Light Source

In another of its aspects the present invention is embodied in a wavelength-filtered light source.

The wavelength-filtered light source includes (1) an electric light having a body defining a volume; where the exterior of the body is covered with (2) a material substantially opaque to light emitted in the blue and/or ultraviolet spectral regions but substantially totally transmissive to visible light emitted by the electric light outside these spectral regions.

The electric light is preferably a fluorescent light having a tubular cylindrical volume.

The material is preferably polyimide, is more preferably polyimide film, and is still more preferably self-adhesive polyimide film.

3. A Wavelength-Filtered Fluorescent Light

In yet another of its aspects the present invention is embodied in a wavelength-filtered fluorescent light having a fluorescent/light tube defining a tubular volume. This tube is covered with flexible polyimide sheet material substantially opaque light emitted in the blue and ultraviolet spectral regions but substantially totally transmissive to visible light emitted by the electric light outside these spectral regions.

This flexible polyimide sheet material is preferably self-adhesive. It is preferably applied to fluorescent light tube by wrapping.

The preferred sheet, or most-preferred self-adhesive, polyimide sheet material may be applied to the fluorescent light tube by supplemental use of (i) adhesive and/or (ii) double-sided-sticky tape. The double-sided-sticky tape is not normally itself made from polyimide film, but it can be so made.

These and other aspects and attributes of the present invention will become increasingly clear upon reference to the following drawings and accompanying specification.

### BRIEF DESCRIPTION OF THE DRAWINGS

Referring particularly to the drawings for the purpose of illustration only and not to limit the scope of the invention in any way, these illustrations follow:

FIG. 1 shows a prior art standard plain fluorescent light bulb.

FIG. 2 shows the adaptation of prior fluorescent light bulb of FIG. 1 to, in accordance with the present invention, create a light source, in the form of a fluorescent lamp, that adapted to block blue and UV light emission.

FIG. 3 is a cross-sectional view, taken along aspect line 3-3, of the light source in accordance with the present invention previously seen in FIG. 2 which light source, in the form of a fluorescent lamp, is adapted to block blue and UV light emission.

FIG. 4 shows an incandescent lamp adapted to block blue and UV light emission in accordance with the present invention.

FIG. 5 is a cross-sectional view, taken along aspect line 5-5 within FIG. 4, of the light source in accordance with the present invention as was previously seen in FIG. 4.

FIG. 6, consisting of FIGS. 6a and 6b, are detail views of the use of polyimide film as a combined shield and cover to a light fixture.

FIG. 7, consisting of FIGS. 7a and 7b, are views of a step in the application of polyimide to, respectively, a fluorescent, and an incandescent, lamp by process of dip coating.

FIG. 8 is a view of a step in the application of polyimide to a fluorescent by process of ring coating.

FIG. 9 is a cross-sectional view, taken along aspect line 9-9 within FIG. 8, of the fluorescent lamp to which polyimide is applied by process of ring coating as was previously seen in FIG. 8.

FIG. 10, consisting of FIGS. 10a and 10b, are views of a step in the application of polyimide to, respectively, a fluorescent, and an incandescent, lamp by process of spraying.

FIG. 11 illustrates the use of a blue and UV light sources, particularly fluorescent lamps, adapted to block blue and UV light emission in accordance with the present invention in use to illuminate a workroom.

### DESCRIPTION OF THE PREFERRED EMBODIMENT

The following description is of the best mode presently contemplated for the carrying out of the invention. This description is made for the purpose of illustrating the general principles of the invention, and is not to be taken in a limiting sense. The,scope of the invention is best determined by reference to the appended claims.

Although specific embodiments of the invention will now be described with reference to the drawings, it should be understood that such embodiments are by way of example only and are merely illustrative of but a small number of the many possible specific embodiments to which the principles of the invention may be applied. Various changes and modifications obvious to one skilled in the art to which the invention pertains are deemed to be within the spirit, scope and contemplation of the invention as further defined in the appended claims.

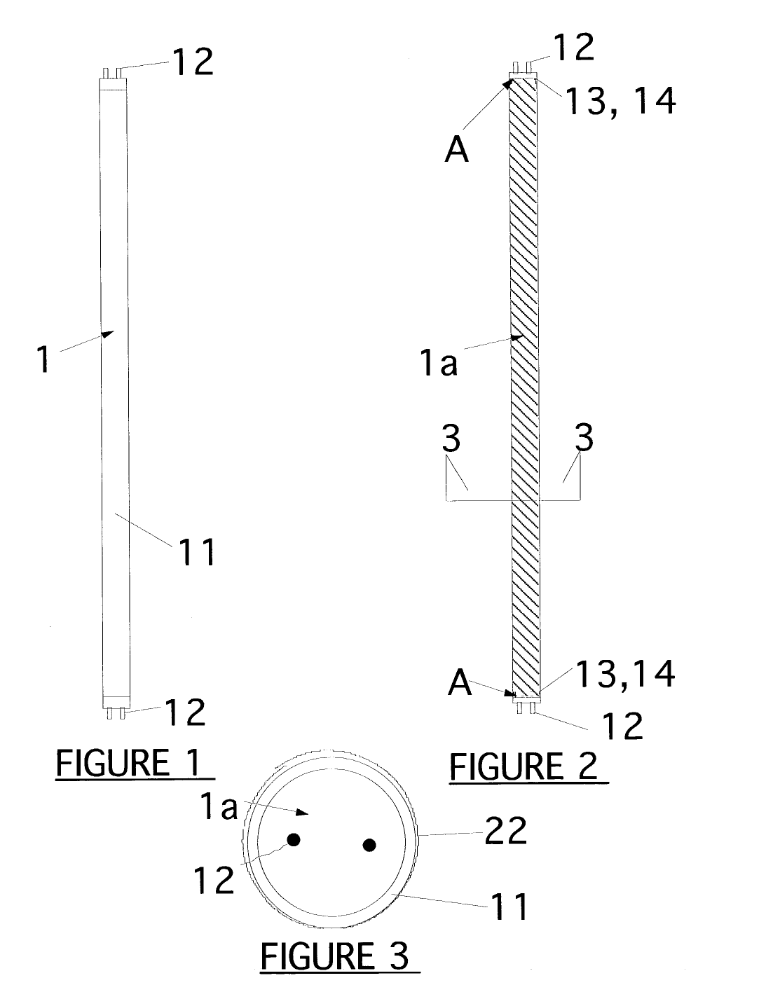

A prior art standard plain fluorescent light bulb 1 is shown in FIG. 1. The bulb 1 includes a cylindrical glass tube 11 sealed with electrical connector end caps 12 to enclose gases that can be excited to fluorescence, and the emission of light including at ultraviolet and blue wavelengths, by an electrical current flowing between the electrical connector end caps 12.

An adaptation of prior art fluorescent light bulb 11 of FIG. 1 in order to, in accordance with the present invention, create a light source that is adapted to block blue and UV light emission is shown in plan view in FIG. 2, and in cross-sectional view in FIG. 3. The light bulb la is now covered in all areas of light emission where light emission occurs—namely, the transparent portions of the glass tube 11—with a material 22 (best observed in FIG. 3) that is (i) selectively opaque to blue, and to ultraviolet, light while remaining (ii) transparent to light of other wavelengths.

The UV- and blue-blocking material 22 may in particular be polyimide film. The preferred polyimide film if of a thickness less than 0.0005″, and is more preferably of types 300KN, 100CB, 200KJ, 500H, 300H, 500HN, 300HN, 100HN or 50HN all available from DuPont High Performance Materials, U.S. Rt. 23 DuPont Road, Circleville, Ohio. 43113. Polyimide sheet of other manufacturers is also suitable. The light transmittance of the Dupont polyimide materials are, in particular, available over a wavelength range from 200 to 800 nanometers by request to the manufacturer.

Although the light transmittance of all the polyimide materials is substantially the same—with shorter (and more energetic) ultraviolet and blue wavelength light blocked while light of longer wavelengths is transmitted un-attenuated—the various available polyimide sheet materials are differentiated—as well as by sheet width and sheet thickness and roll length—by the “roll-off” wavelength (frequency) at which opacity changes to transmission. This “roll-off” wavelength (frequency) is accordingly adjustable in accordance with the particular polyimide selected, and different users of the blocked-wavelength light sources of the present invention will commonly specify the range of frequencies that are desired to be blocked, or at least the minimum light wavelength (the maximum light frequency) at which transmittance can be tolerated.

Referring to FIG. 2, the film 22 should partially overlap the metal electrodes 12 and the regions A and be sealed to avoid light leakage. Both this sealing, and the general holding of the circumferentially wrapped polyimide sheet material 12, may be aided and abetted by adhesive 13 and/or double-sided sticky tape 14. When used, either the adhesive and/or double-sided sticky tape will normally appear only in, and as, a small, patch-like, area, as best seen in FIG. 2. A light-opaque putty may be necessary to bridge and great differences in diameter between the glass envelope 11 and the end cap electrodes 12.

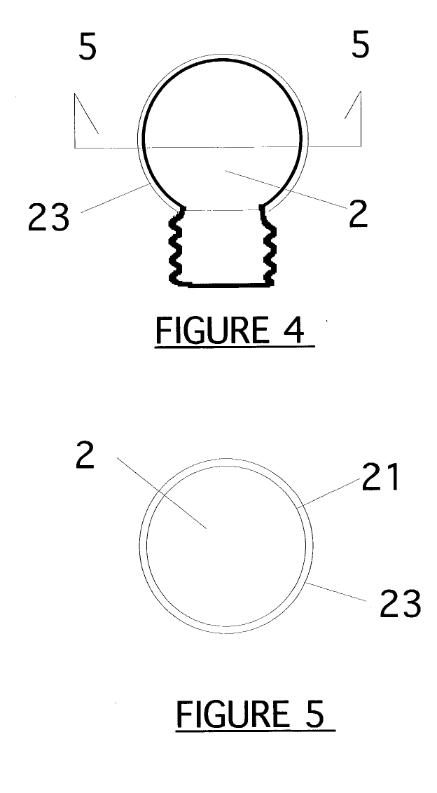

An incandescent lamp 2 adapted by a covering material 23 to block blue and UV light emission in accordance with the present invention is shown in FIG. 4. All standard bulbs such as types T8 and T14 in lengths from 4 to 8 feet and more are suitably covered with polyimide sheet. The covering material may again be polyimide sheet, as in the fluorescent light of FIGS. 2 and 3, but is more preferably a polyimide resin. Type RC5019 available from IST Corporation is preferred. This resin is preferably diluted with M-methyl 2-pyrrolid to achieve a proper viscosity for application. Other manufacturers of polyimide resin suitable for use in accordance with the present invention in the coating of lamps and light fixtures include Dow Corning and EPO-TEK, Inc.

The typical application of this polyimide resin 23, which cures to hardness, is shown in cross-sectional view, taken along aspect line 5-5 of FIG. 4, in FIG. 5. The polyimide resin 23 is applied over the entire surface of the glass bulb 21, including by process of dipping.

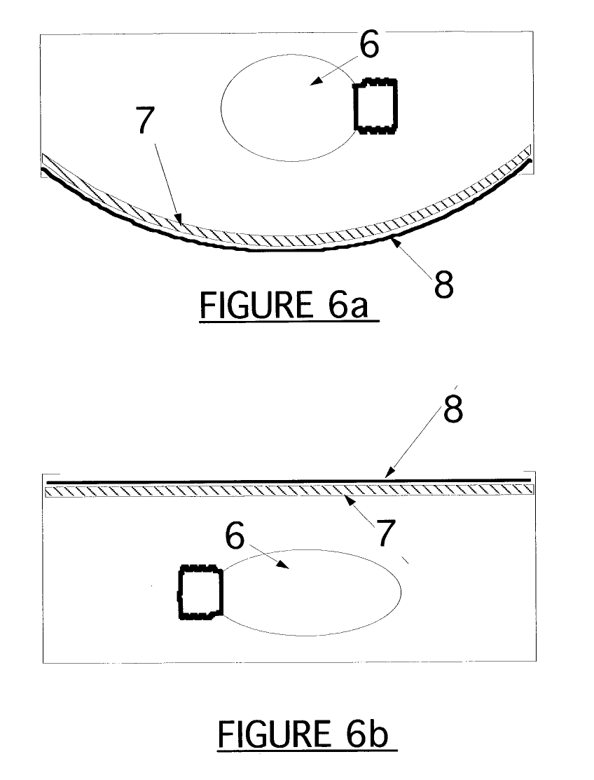

The use of polyimide film as a combined shield and cover to a light fixture is shown in FIGS. 6a and 6b. A light source 6 in each figure emits broad spectrum radiation including at least some ultraviolet and/or blue wavelength light radiation. This light is passed through a clear glass or other transparent/translucent material substrate 7 to which is applied, by like methods as for application to lamps, a covering of polyimide 8. In particular, the polyimide covering 8 can be applied as self-adhesive polyimide sheet, or as polyimide sheet held with polyimide tape. The polyimide covering 8 may alternatively be applied by any of painting, spray painting, spin coating, dip coating, or other methods as are known in the art for the application of liquids to surfaces.

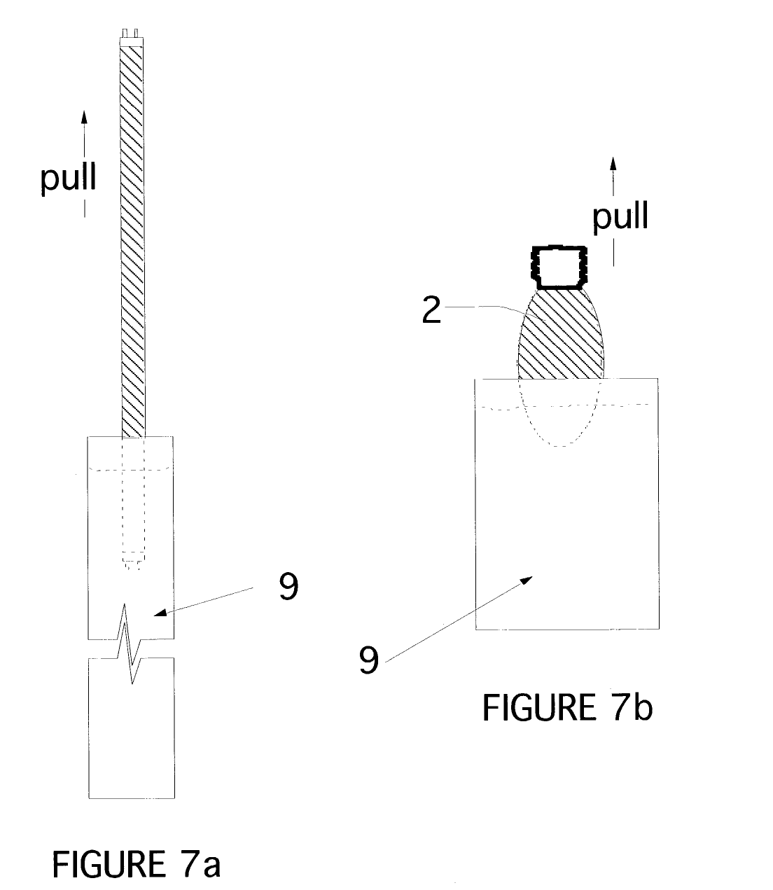

Equivalent views of a same step in the application of polyimide to, respectively, a fluorescent, and an incandescent, lamp by process of dip coating are respectively shown in FIGS. 7a and 7b. Each process uses a bath 9 containing liquid polyimide resin, and of suitable size and shape to dip an electric lamp. The extraction of the tube of a fluorescent lamp is illustrated in FIG. 7a, the extraction of an incandescent lamp in FIG. 7b. Extraction should be smooth, at a slow and uniform rate of approximately 1 inch per minute. The exact extraction (i.e., dipping) rate is empirically determined by the resin used, and the desired thickness of the coating.

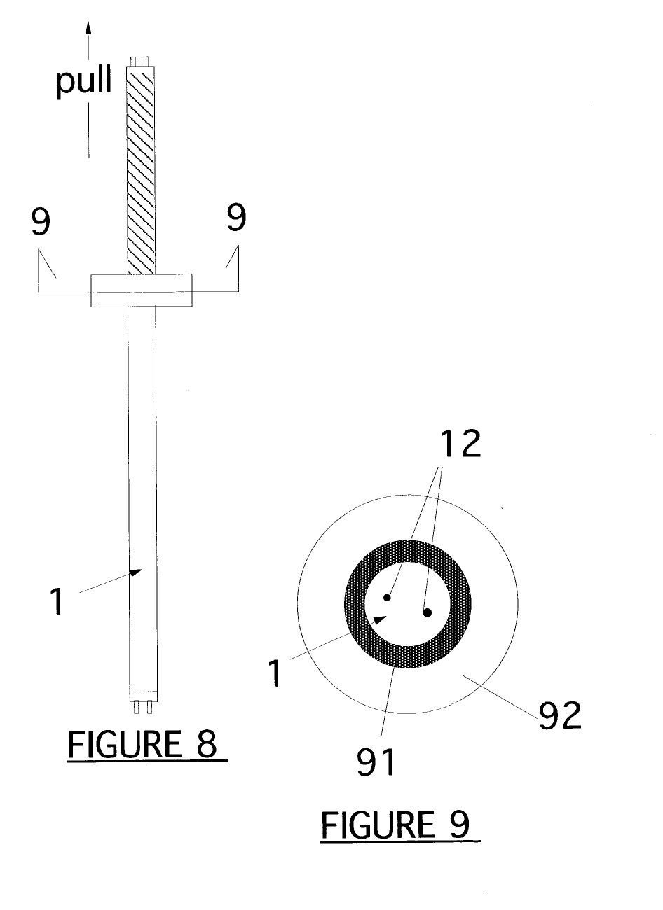

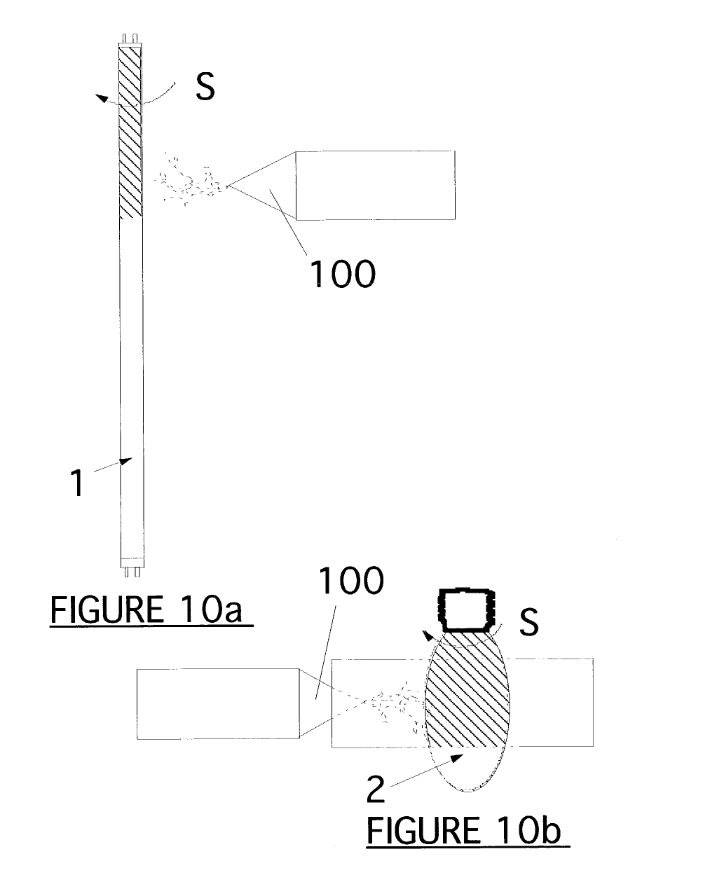

A view of a step in the application of polyimide to a fluorescent lamp 2 by process of ring coating is shown in FIG. 8. A cross-sectional view, taken along aspect line 9-9 within FIG. 8, of this ring coating process is shown in FIG. 9. The ring coating is realized by pulling the tube of the fluorescent lamp 2 through a ring of felt 91, or other absorbent material, that is soaked with polyimide resin from a surrounding reservoir 92. The felt 91 is fed from the reservoir 92 (best seen in FIG. 9) in a similar way that the porous tip of a felt pen is fed from the reservoir of the pen, that is, by capillary action. As with dip coating, the lamp 2 should be pulled at a controlled, smooth and uniform rate to ensure controlled thickness and uniformity of the applied polyimide coating.

A view of a same step in the application of polyimide to, respectively, a fluorescent, and an incandescent, lamp by process of spraying, is shown in FIGS. 10a and 10b. The fluorescent lamp 1 (shown in FIG. 10a), or the incandescent lamp 2 (shown in FIG. 10b) is both (i) pulled past a spray head 110 spraying polyimide resin, and simultaneously (ii) spun, or rotated, in the direction of arrows S (or the opposite to this direction). The goal is, of course, to controllably apply the polyimide to the surface of the lamps 1, 2. The sprayed application may alternatively be realized by pulling the bulbs 1, 2 through a chamber where there is a constant spray, or mist, or polyimide. Clearly a uniform pull and spin rate usefully ensures a uniform coating, with the thickness of the applied polyimide being primarily determined by the pull rate.

The same diagrams of FIGS. 10a and 10b may be adapted to illustrate application of polyimide by brushing, as may be readily be conceptualized.

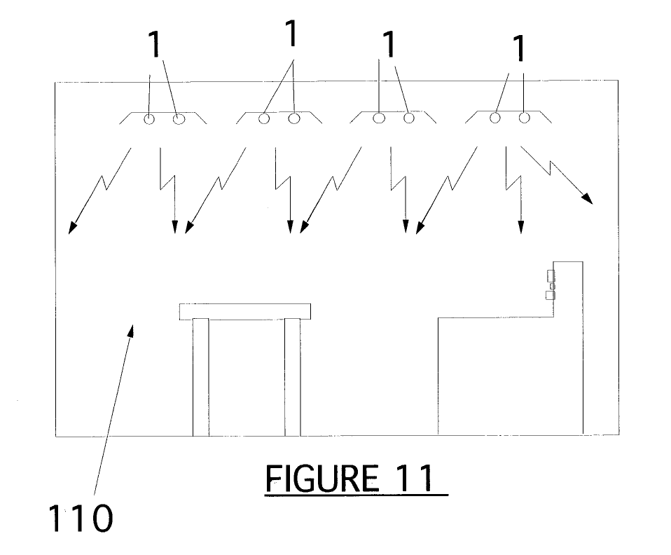

The use of a blue and UV light sources—particularly fluorescent lamps 1—that adapted to block blue and UV light emission in accordance with the present in illuminating a workroom 110 is illustrated in FIG. 11.

Accordingly, the embodiments have shown that polyimide film can be applied by either an adhesive, double sticky tape, or, as is most preferred, the polyimide sheet can be procured in tape form and applied directly to a lamp such as of the fluorescent tube or incandescent types, or to a light fixture. Likewise, polyimide resin can be applied by painting, spraying or, preferably, dipping to the complex curves of any of an incandescent light bulb, a fluorescent lamp, or a light fixture.

In accordance with the preceding explanation, variations and adaptations of the UV- and/or blue-free light source in accordance with the present invention will suggest themselves to a practitioner of the lighting arts. For example, several light sources might be placed in close proximity before the entire bunch was collectively enclosed in a large-diameter tube, or sphere, of polyimide.

In accordance with these and other possible variations and adaptations of the present invention, the scope of the invention should be determined in accordance with the following claims, only, and not solely in accordance with that embodiment within which the invention has been taught.

What is claimed is:

1. An illuminated workroom comprising:
a room enclosing a volume; and
a broad spectrum light source illuminating the workroom, the light source emitting light including light in blue and ultraviolet spectral regions and also visible light outside these spectral regions; covered with
material substantially opaque to light emitted by the light source in the blue and ultraviolet spectral regions but substantially totally transmissive to visible light emitted by the light source outside these spectral regions.

2. The illuminated workroom according to claim 1 wherein the light source comprises:
a light fixture containing broad spectrum electric lamps producing the light including light in blue and ultraviolet spectral regions;
wherein the material substantially opaque to light emitted by the electric lamps in the blue and ultraviolet spectral regions is upon the light fixture, and between the electric lamps and the workroom.

3. The illuminated workroom according to claim 1 wherein the light source comprises:
a broad spectrum electric lamp producing the light including light in blue and ultraviolet spectral regions;
wherein the material substantially opaque to light emitted by the light source in the blue and ultraviolet spectral regions is between the electric lamp and the workroom.

4. The illuminated workroom according to claim 3 wherein the material is upon the electric lamp.

5. The illuminated workroom according to claim 1 wherein the light source comprises:
a fluorescent electric lamp emitting the light including light in blue and ultraviolet spectral regions; and
wherein the material substantially opaque to light in the blue and ultraviolet spectral regions is applied to the fluorescent electric lamp.

6. The illuminated workroom according to claim 1 wherein the material comprises:
polyimide.

7. A wavelength-filtered lamp comprising:
an electric lamp having a body defining a volume; to which body is applied
a material substantially opaque to light emitted in the blue and ultraviolet spectral regions but substantially totally transmissive to visible light emitted by the light source outside these spectral regions.

8. The wavelength-filtered lamp according to claim 7 wherein the electric lamp comprises:
a fluorescent light having a tubular cylindrical volume.

9. The wavelength-filtered lamp according to claim 7 wherein the electric lamp comprises:
an incandescent light bulb.

10. The wavelength-filtered lamp according to claim 7 wherein the material applied to the electric lamp comprises:
polyimide.

11. The wavelength-filtered lamp according to claim 10 wherein the polyimide material applied to the electric lamp comprises:
polyimide sheet.

12. The wavelength-filtered lamp according to claim 10 wherein the polyimide material applied to the electric lamp comprises:
polyimide resin.

13. A wavelength-filtered light comprising:
a fluorescent electric lamp in shape of a tube; to which tube is applied
polyimide.

14. The wavelength-filtered light according to claim 13
wherein the fluorescent electric lamp emits light including light in blue and ultraviolet spectral regions and also visible light outside these spectral regions; and
wherein the polyimide is of type and thickness so as to be substantially opaque to the light emitted by the lamp in the blue and ultraviolet spectral regions but substantially totally transmissive to the visible light emitted by the lamp outside these spectral regions

15. The wavelength-filtered light according to claim 13 wherein the applied polyimide material comprises:
flexible polyimide sheet applied to the fluorescent electric lamp tube by wrapping.

16. The wavelength-filtered fluorescent light according to claim 15 further comprising:
adhesive supporting application of the flexible polyimide sheet material to the fluorescent light tube by wrapping.

17. The wavelength-filtered fluorescent light according to claim 15 further comprising:
double-side stick tape supporting application of the flexible polyimide sheet material is applied to the fluorescent light tube by wrapping.

18. The wavelength-filtered fluorescent light according to claim 14 wherein the applied polyimide material comprises:
polyimide resin applied to the fluorescent electric lamp tube by coating.
